(19) United States
(12) Patent Application Publication
(10) Pub. No.: US 2023/0356240 A1
(43) Pub. Date: Nov. 9, 2023

(54) FLUID SPRAYING DEVICE FOR CLEANING A SURFACE OF A MOTOR VEHICLE

(71) Applicant: VALEO SYSTEMES D'ESSUYAGE, La Verriere (FR)

(72) Inventors: Maxime BAUDOUIN, La Verriere (FR); Giuseppe GRASSO, La Verriere (FR); Denis THEBAULT, La Verriere (FR); Yoann DOLLE, La Verriere (FR); Adrien PERET, La Verriere (FR)

(73) Assignee: VALEO SYSTEMES D'ESSUYAGE, La Verriere (FR)

(21) Appl. No.: 18/042,699

(22) PCT Filed: Jul. 30, 2021
(86) PCT No.: PCT/EP2021/071407

§ 371 Date: Feb. 23, 2023

(30) Foreign Application Priority Data
Aug. 24, 2020 (FR) 2008626

(51) Int. Cl. B05B 15/65; B05B 9/04; B05B 1/04; B05B 1/30

(52) U.S. Cl. CPC B05B 1/3013; B05B 1/044; B05B 9/0423; B05B 15/65; B60S 1/56

(57) ABSTRACT

The present invention relates to a fluid spraying device for a system for cleaning a surface of a motor vehicle, the spraying device includes a solenoid valve configured to allow or prevent the passage of fluid towards a spraying member, the solenoid valve includes a hydraulic system and an electromagnetic system, the hydraulic system includes at least one fluid dispensing member that includes at least a fluid inlet end-fitting, a circulation chamber and a fluid outlet end-fitting in fluid communication with the spraying member, the electromagnetic system being configured to allow or prevent the passage of fluid through the circulation chamber, and the spraying member includes at least a connecting tube and a spray nozzle, the connecting tube being fastened directly to the fluid outlet end-fitting.

### TECHNICAL FIELD

The present invention falls within the field of systems for cleaning optical sensors of a motor vehicle, and more particularly concerns a device for spraying cleaning fluid, notably equipped with a solenoid valve, incorporated in such a cleaning system.

### BACKGROUND OF THE INVENTION

Modern vehicles are often equipped with driving assistance systems, whether to assist the driver during parking maneuvers or when driving in traffic in relation to other vehicles, or to replace the driver in autonomous driving vehicles. Each of these systems has at least one sensor making it possible to identify the surroundings of the vehicle, the sensor being able to consist for example, and non-exhaustively, of a camera or radar.

Each sensor is configured to acquire a datum relating to the surroundings around the vehicle and to this end is exposed to various types of sprayed objects or dirt, which can subsequently adversely affect the reliability of the data acquired. However, and notably when these sensors are implemented within the scope of an autonomous driving function, irrespective of its degree of autonomy, it is essential for the safety of all road users that the data acquired are reliable.

Within this context, the sensors are usually equipped with cleaning installations, which can take various forms and among which installations comprising a system for spraying cleaning fluid onto the optical surface of the sensors are known.

### SUMMARY OF THE INVENTION

These cleaning fluid spraying systems have at least one body arranged in the vicinity of the sensor for directing the fluid onto the optical surface and a duct through which the cleaning fluid arrives in the body from a storage reservoir. These spraying systems may furthermore have other components and notably solenoid valves connected to an electronic control circuit, for example, the management of these solenoid valves making it possible to prevent or allow the entry of the cleaning fluid into the body in order to be sprayed onto the optical surface.

The significant number of optical sensors installed in the vehicle, each of which is intended to perform proposed driving assistance functions in the vehicle, requires the provision of a plurality of fluid spraying devices, each being associated with a sensor and having a fluid spraying member directed toward the optical surface to be cleaned of this sensor.

It is known to equip each of these spraying devices with a solenoid valve managed to allow or prevent the entry of cleaning fluid in the direction of the corresponding spraying member, it being understood that it is desirable to be able to clean specifically a given dirty sensor without thereby cleaning the remaining, immaculate sensors, for the sake of saving on cleaning fluid.

More particularly, in the prior art, it is known to dispose an array of solenoid valves next to one another, in the vicinity of the electronic control unit making it possible to manage them, and to provide a connection between each solenoid valve and the corresponding fluid spraying member via a flexible duct conveying the cleaning fluid from the solenoid valve.

The invention falls within this context and aims to improve the performance of such an architecture, and notably the reaction time between the activation of the solenoid valve allowing or preventing the passage of cleaning fluid in the direction of the spraying member and the spraying, or stoppage of spraying, effectively realized at the outlet of the spraying member. It should be understood that the shortening of this reaction time makes it possible to further refine the quality of the information acquired by the sensor.

The main subject of the present invention is therefore a fluid spraying device for a system for cleaning a surface of a motor vehicle, the spraying device comprising a solenoid valve configured to allow or prevent the passage of fluid in the direction of a spraying member, said solenoid valve having a hydraulic system and an electromagnetic system, the hydraulic system comprising at least one fluid distribution member which has at least one fluid inlet endpiece, a circulation chamber, and a fluid outlet endpiece in fluidic communication with the spraying member, the electromagnetic system being configured to allow or prevent the passage of fluid through the circulation chamber, characterized in that the spraying member comprises at least one coupling tube and a spray nozzle which are formed in one piece, the coupling tube being directly fixed to the fluid outlet endpiece.

In other words, the present invention proposes a spraying device which is distinctive in that it comprises a solenoid valve to which the spraying member is directly fixed, without an intermediate flexible duct. In this way, the reaction time for implementing or preventing the spraying of cleaning fluid onto the surface to be cleaned is improved, since the fluid being allowed to enter the solenoid valve is located directly in the spraying member at the outlet of the solenoid valve, without it needing to circulate within a flexible duct.

The solenoid valve makes it possible to control the circulation of a cleaning fluid in a cleaning system, the fluid circulating in the hydraulic system by passing respectively through the fluid inlet endpiece, the circulation chamber, and the fluid outlet endpiece, before entering the spraying member. The electromagnetic system may receive a command ordering it to prevent the circulation of the fluid in the circulation chamber or to let this circulation take place freely. To that end, the electromagnetic system comprises a member able to receive this command, to process it and to bring about a mechanical action preventing the circulation of the fluid or letting it take place freely.

The cleaning fluid may be any type of fluid provided that it enables an action of cleaning the surface onto which it is sprayed, and may notably consist of air, water, soapy water, or any other product generally used to clean a surface. Furthermore, the surface onto which the fluid is sprayed may in this case consist of various types of surfaces of the vehicle and notably glazed surfaces of sensor/emitter optical surface type, and for example an optical surface of an optical emitter device or an optical receiver device.

The coupling tube surrounds the fluid outlet endpiece on the one hand to enable a continuous passage for cleaning fluid in the direction of the spray nozzle formed at the end of the spraying member and on the other hand to make it possible to fix the spraying member directly to the solenoid valve, without an interposed flexible duct.

The distribution member and the coupling tube may be considered to be rigid bodies in that these elements are not elastically deformable or are slightly elastically deformable such that they have the advantage of keeping their overall shape once the spraying device has been assembled, despite the stresses to which they can be subjected in their standard condition of use. Notably, “rigid coupling tube” is understood to mean that the coupling tube is different than a flexible duct.

The coupling tube and the spray nozzle are formed in one piece, this meaning that they form portions of a single monobloc part and that they cannot be moved apart from one another without destroying the spraying member that they contribute to forming.

According to an optional feature of the invention, the spraying member may comprise a distribution body interposed between the coupling tube and the spray nozzle, notably to give the spraying member a bent profile. Here, too, it should be understood that each of these portions contributes to forming the one-piece spraying member. The distribution body takes the form of a rigid pipe, one portion of which is connected to the coupling tube and the other portion of which is connected to the spray nozzle, and each of these portions is configured to let the cleaning fluid pass through in order that it can circulate from the first end of the coupling tube, facing the solenoid valve, to the spray nozzle.

According to an optional feature of the invention, the spraying member is fixed directly to the fluid outlet endpiece by reversible fixing means.

The spraying member may thus be mounted on or dismounted from the fluid outlet endpiece and therefore the solenoid valve. “Reversible” is understood to mean that the mounting and dismounting of the spraying member does not cause one of the solenoid valve elements to break, such that these operations can be performed multiple times, and that this mounting and dismounting requires the intervention of a user, the vibrations that can occur in normal running conditions not being able by themselves alone to cause the spraying member and the solenoid valve to become detached.

According to a series of features of the invention, considered on their own or in combination, it is possible to provide that:

the reversible fixing means are borne respectively by the fluid outlet endpiece and by the coupling tube of the spraying member, at least one from among the fluid outlet endpiece and the coupling tube being able to take different positions by elastically deforming;

the reversible fixing means have a snap-fastening finger projecting from a wall delimiting a sleeve forming the fluid outlet endpiece, said snap-fastening finger being configured to interact with a hole formed in the wall delimiting the coupling tube;

the reversible fixing means have a protuberance which projects from a wall delimiting the coupling tube toward the inside of this coupling tube and is configured to interact with a stop projecting from a sleeve forming the fluid outlet endpiece, after elastic deformation of the wall bearing the protuberance and/or of the sleeve bearing the stop.

These features notably implement a snap-fastening system making it possible to fix the spraying member to the solenoid valve. “Snap-fastening” is understood to mean that one of the elements deforms slightly under the application of a force and then returns to its initial shape, locking the spraying member and the rigid body in position. This snap-fastening system makes it possible to avoid using a particular fixing technique, such as adhesive bonding, welding or another fixing technique.

According to an optional feature of the invention, the reversible fixing means have a locking element separate from the spraying member and from the fluid outlet endpiece, the locking element being elastically deformable and able to interact with at least one hole formed in the wall delimiting the coupling tube.

According to another optional feature of the invention, the spraying device moreover comprises a poka-yoke device.

The spraying member has the function of spraying a fluid onto a surface of the vehicle, and notably an optical surface of a sensor/emitter in the vicinity of which the spraying member is disposed. To that end, the spray nozzle must be positioned such that the jet of cleaning fluid leaving the spray nozzle is correctly oriented in the direction of the optical surface. The poka-yoke device makes it possible to propose a single possible direction for mounting the spraying member on the distribution member, such that the spraying member, and by extension the spray nozzle, can thus be positioned only in one way on the distribution member, in order to limit a potential mounting error and thus ensure the correct positioning of the spray nozzle.

According to an optional feature of the invention, the poka-yoke device has a plurality of positioning tabs projecting from the coupling tube so as to at least partially cover the distribution member and among which at least one positioning tab has a shape and/or dimensions different to those of the other positioning tabs, the poka-yoke device moreover having a low wall formed at the periphery of the distribution member to interact with the positioning tab that has a shape and/or dimensions different to those of the other positioning tabs.

According to another optional feature of the invention, the poka-yoke device may comprise a system for adjusting the position of the spraying member.

It will be understood that the poka-yoke device of the spraying member allows only one possible mounting direction and thus fixes the position of the spraying member with respect to a frame of reference on the solenoid valve, and for example a low wall formed at the periphery of the distribution member. The system for adjusting the position of the spraying member makes it possible to adapt the position of this frame of reference, once the spraying member has been mounted on the distribution member or beforehand, to ultimately set the position of the spraying member with respect to the surface to be cleaned. By way of example, the frame of reference may be secured to a notched ring which is mounted on the distribution member of the solenoid valve and is able to be precisely adjusted and then fixed in terms of position.

According to another optional feature of the invention, the fluid outlet endpiece has a chamfered free end to facilitate the mounting of the spraying member around this outlet endpiece.

The spraying member is mounted on the fluid outlet endpiece, for the purpose of being secured to the solenoid valve, by sliding the coupling tube around the sleeve forming the fluid outlet endpiece. The chamfer at the end of the fluid outlet endpiece thus facilitates the entry of the sleeve into the coupling tube.

According to an optional feature of the invention, the spraying member has a conveying duct, which extends within the spraying member continuously from the coupling tube to the spray nozzle, and in which is inserted the fluid outlet endpiece, the conveying duct having a shoulder arranged between two segments of the conveying duct that have different passage cross sections, the shoulder forming an end stop for the insertion of the fluid outlet endpiece into the spraying member.

Another subject of the present invention is a system for cleaning a surface of a motor vehicle, comprising a pump conveying a cleaning fluid through a duct to at least one solenoid valve of a spraying device as described above, the solenoid valve being configured to allow or prevent the spraying of the fluid onto the surface via the spraying member.

### BRIEF DESCRIPTION OF DRAWINGS

Further features, details and advantages of the invention will become more clearly apparent from reading the following description, and from multiple exemplary embodiments given by way of nonlimiting indication, with reference to the appended schematic drawings, in which:

FIG. 1 is a schematic depiction of a motor vehicle equipped with a driving assistance system having multiple sensors, each sensor being in this case associated with a cleaning fluid spraying device according to the invention, having a solenoid valve and a spraying member that are secured together without an interposed flexible duct;

FIG. 2 is a partial schematic depiction, in perspective, of a cleaning system equipped with two cleaning fluid spraying devices according to the invention, which are configured to spray cleaning fluid onto an optical surface of a sensor;

FIG. 3 is a perspective depiction of a cleaning fluid spraying device according to a first embodiment of the invention;

FIG. 4 is a perspective depiction from another angle of the cleaning fluid spraying device shown in FIG. 3;

FIG. 5 is an exploded view of the cleaning fluid spraying device shown in FIG. 3;

FIG. 6 is a view in longitudinal section of the cleaning fluid spraying device shown in FIG. 3;

FIG. 7 is a perspective view showing details of components of the cleaning fluid spraying device shown in FIG. 3, including a distribution member of the solenoid valve and a spraying member;

FIG. 8 is a perspective view of the spraying member of FIG. 7;

FIG. 9 is a partial depiction, in perspective, of a spraying device according to a second embodiment, in this case clearly showing the distribution member of the solenoid valve and the spraying member;

FIG. 10 is a longitudinal section through part of the distribution member and the spraying member of FIG. 9;

FIG. 11 is a partial depiction, in perspective, of a spraying device according to a third embodiment, in this case clearly showing the distribution member of the solenoid valve and the spraying member;

FIG. 12 is a longitudinal section through part of the distribution member and the spraying member of FIG. 11.

### DETAILED DESCRIPTION OF THE INVENTION

The features, variants and different embodiments of the invention may be combined with one another, in various combinations, provided that they are not mutually incompatible or exclusive. In particular, it is possible to imagine variants of the invention that comprise only a selection of features described below, independently of the other characteristics described, if this selection of features is sufficient to confer a technical advantage and/or to differentiate the invention from the prior art.

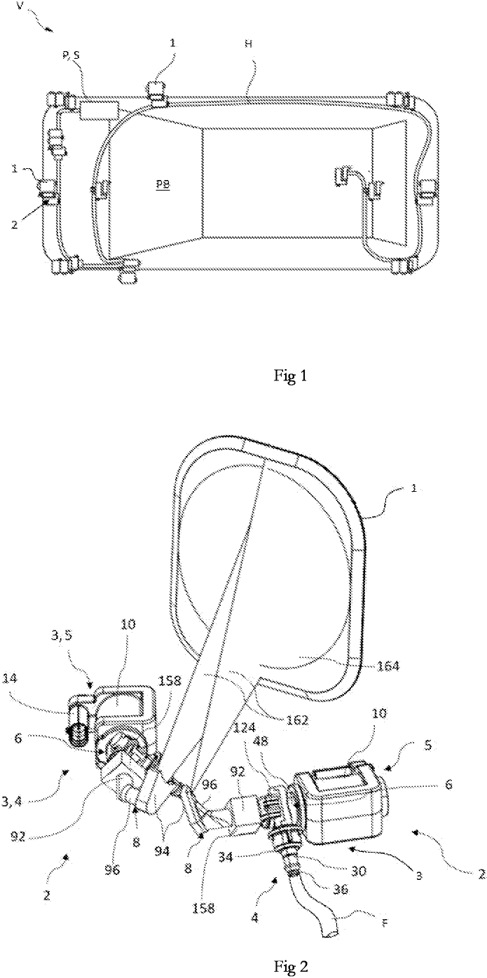

FIG. 1 shows a motor vehicle V equipped with a cleaning system according to the invention, which makes it possible to clean at least one surface of the vehicle. Such a surface to be cleaned may consist for example of a windscreen PB or else a rear window of the vehicle, or it may consist of an optical surface of one of the optical sensors/emitters 1 with which the vehicle is equipped.

The cleaning system notably comprises a duct, or hydraulic circulation bus, H able to make it possible for a cleaning fluid to circulate, and cleaning fluid spraying devices 2 disposed in the vehicle, respectively being associated with one of the optical sensors/emitters 1. In the example illustrated in FIG. 1, a spraying device 2 is specifically dedicated to cleaning a single glazed surface, but it will be understood from reading FIG. 2, for example, that multiple spraying devices 2 may be dedicated to cleaning one and the same glazed surface, provided that, in accordance with the following description, each spraying device 2 has a dedicated solenoid valve to which a spraying member is directly fixed.

More particularly, in the example illustrated, each of the spraying devices 2 is hydraulically connected to the hydraulic distribution bus H, for example via supply hoses F, which are partially shown in FIG. 2, and these spraying devices 2 are connected to this hydraulic distribution bus independently of one another, and in separate and successive zones of the hydraulic distribution bus that forms in this case a bus common to the plurality of spraying devices. In this nonlimiting example of implementation in the vehicle, it will be understood that a single hydraulic distribution bus ensures the supply of cleaning product to all of the spraying devices 2 mounted on this vehicle.

The cleaning system furthermore comprises a pump P and a cleaning fluid storage reservoir S. The pump P is configured to take the cleaning fluid from the storage reservoir and to supply cleaning fluid continuously to the hydraulic distribution bus H.

In this context, spraying devices 2 are intended both to clean an optical surface of a sensor/emitter 1 used for automatic analysis of the road scene, that is to say analysis using the electronics of the vehicle in order notably to manage a driving assistance and/or maneuvering assistance device of this vehicle, and to clean a glazed surface of the vehicle interior or an optical surface of a sensor/emitter used solely for direct analysis by the driver of the vehicle. What should be understood by an “optical surface of a sensor/emitter” is that the cleaning system according to the invention is applicable for cleaning optical emitter devices, for cleaning optical receiver devices, and for cleaning optical emitter/receiver devices.

To optimize the cleaning of a glazed surface, and for example an optical surface of an optical sensor, two spraying devices 2 may be arranged in the vicinity of one another such that their respective spraying members face one and the same glazed surface, as illustrated in FIG. 2. Each of the spraying devices is in this case disposed symmetrically with respect to the other in a plane perpendicular to the glazed surface, so as to optimize the spray of cleaning fluid 162 in this case onto the optical surface 164 of an optical sensor 1.

A cleaning fluid spraying device 2 according to the invention is disposed in the vicinity of an optical sensor/emitter 1 and of its glazed surface to be cleaned. Notably, it has a solenoid valve 3 and a spraying member 8, the spraying device being configured according to the invention in that the member is directly fixed to the solenoid valve, notably by reversible fixing means of elastically deforming snap-fastening type, without a flexible duct being arranged between the solenoid valve and the spraying member. In the following description, multiple spraying devices will be described having solenoid valves and spraying members realized according to multiple embodiments.

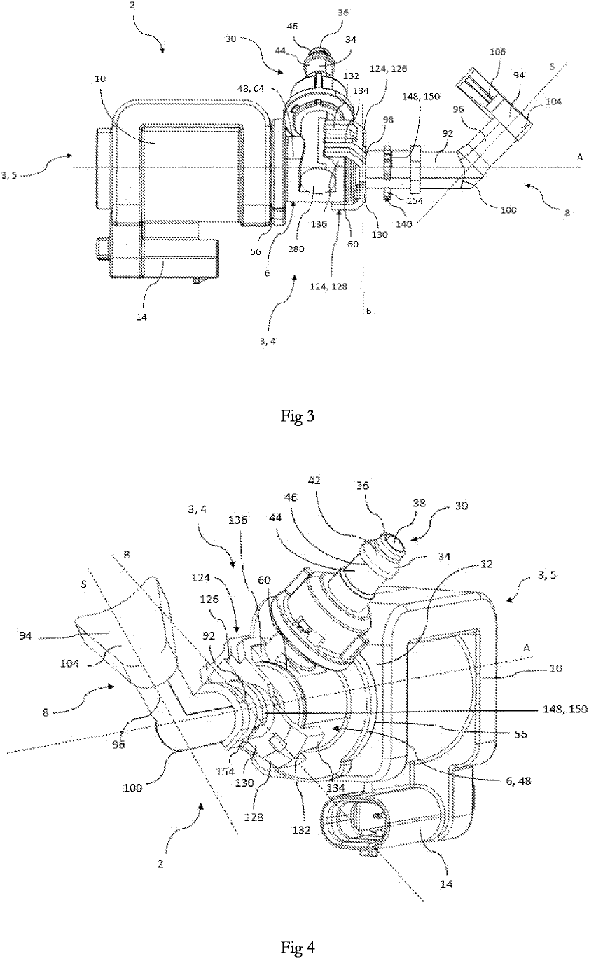

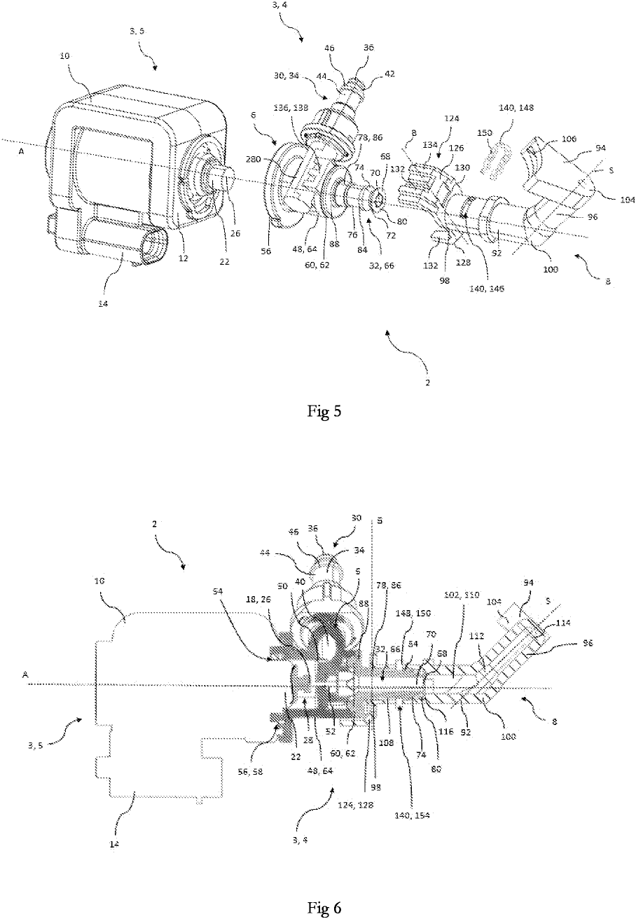

Firstly, reference will be made to FIG. 3, FIG. 4, FIG. 5, and FIG. 6, illustrating a spraying device according to a first embodiment, as a whole.

The solenoid valve 3 comprises a hydraulic system 4, configured to enable leaktight circulation of the cleaning fluid from the supply hose F to the spraying member 8 and thus to the glazed surface of the associated sensor, and an electromagnetic system 5, configured to receive and process the instructions received from control electronics and to consequently influence the circulation of the cleaning fluid in the hydraulic system 4.

In this case, the hydraulic system 4 comprises a distribution member 6 secured to the electromagnetic system 5 and connected directly, according to the invention, to the spraying member 8 directly fixed to the distribution member 6. As it was possible to specify above, it will be understood that the spraying member 8 is in direct contact with the distribution member 6, that is to say no element is interposed between these two objects.

The electromagnetic system 5 comprises a casing 10 configured to house various electronic components and, on a first face 12 of which, means which interact with the distribution member 6 open out. According to a nonlimiting example of the invention, the casing 10 in this case substantially has the shape of a rectangular parallelepiped and thus has a plurality of faces, including said first face 12. The casing 10 furthermore comprises an electrical coupling terminal 14 making it possible to couple the electromagnetic system, and more particularly the components housed in the casing 10, to the electronic control unit.

The electromagnetic system has electromagnetic components which are housed in the casing 10 and enable the movement, along a longitudinal direction A, of a blocking device 18 which can take a clear position, visible in FIG. 6, in which the circulation of cleaning fluid in the hydraulic system 4 is permitted and a blocking position, in which the blocking device 18 prevents the circulation of fluid between the hydraulic system and the spraying member. As illustrated in the view in partial section of FIG. 6, the electromagnetic system in this case is configured such that the blocking device 18 has a piston 22, a free longitudinal end 26 of which is positioned in part outside of the casing 10, in the distribution member of the hydraulic system 4, the piston 22 being able to pass through the first face 12 of the casing 10. In the clear position, the free longitudinal end 26 of the piston is brought toward the first face 12, thereby clearing space for cleaning fluid to pass into the distribution member 6. When the electrical supply to the electromagnetic components is stopped, return means tend to bring the piston 22 and the blocking device 18 into their blocking position, which can prevent the passage of fluid into the distribution member.

As has been specified above, the hydraulic system 4 comprises the distribution member 6 in contact with the electromagnetic system 5. All of the elements making up the hydraulic system 4 provide a seal against leakage of the cleaning fluid circulating through this system.

The distribution member 6 consists of a rigid body, which is not elastically deformable or are slightly elastically deformable, such that it keeps its initial overall shape while the device is operating.

The distribution member 6 has a circulation chamber 28 formed for the passage of cleaning fluid, the circulation chamber communicating with a fluid inlet endpiece 30, on the one hand, and a fluid outlet endpiece 32, on the other hand. As can be seen notably in FIG. 5, the fluid inlet endpiece 30 projects from a lateral face of the distribution member 6 and the fluid outlet endpiece 32 projects from a frontal face of the distribution member 6, away from the electromagnetic system 5.

The circulation chamber 28 is arranged in the direct continuation of the first face 12 of the casing 10, such that the free longitudinal end 26 of the piston 22 of the electromagnetic system 5 mentioned above can extend in the circulation chamber 28 so as to be able to prevent, or not prevent, the circulation of a cleaning fluid in this circulation chamber 28. As has been mentioned above, the piston 22 of the electromagnetic system 5 is shown in FIG. 6 in a clear position, that is to say in a position in which the cleaning fluid can circulate from the fluid inlet endpiece 30 to the fluid outlet endpiece 32 through the circulation chamber 28. And it will be understood that, in the blocking position of the piston 22, the free longitudinal end 26 of the latter is arranged to plug the fluid outlet endpiece 32 of the distribution member 6.

The fluid inlet 30 of the distribution member 6 is configured to be attached, via a flexible duct, to a fluid storage reservoir or to a hydraulic distribution circuit common to all the cleaning fluid spraying devices of the vehicle, as mentioned with reference to FIG. 1 and FIG. 2. In this way, the cleaning fluid is present continuously in the fluid inlet endpiece 30 and the circulation chamber 28, and, according to the configuration of the electromagnetic system 5 and as specified above, the cleaning fluid then circulates toward the fluid outlet endpiece 32 or is blocked at the circulation chamber 28 of the distribution member 6.

As can be seen more particularly in FIG. 4 and FIG. 5, the fluid inlet endpiece 30 takes the overall form of a cylindrical sleeve 34 with variable cross sections. “Variable cross sections” is understood to mean that the sleeve 34 is composed of various portions each with a different outside diameter. More particularly, on a free edge 36 of the sleeve 34, on the opposite side to the circulation chamber 28, the sleeve 34 comprises an inlet opening 38 which enables the inflow of cleaning fluid and is intended to lead into the circulation chamber 28 via a circulation duct 40 formed inside the sleeve 34.

The sleeve 34 is configured to make it possible to sealingly couple a flexible duct so as to enable the inflow of cleaning fluid and notably has a chamfered portion 42 forming a ramp widening the sleeve from the free edge 36, an intermediate portion 44 and a portion for coupling to a cylinder 280 leading into the circulation chamber 28. The flexible duct is fitted around the chamfered portion 42, the ramp shape of which makes it possible to facilitate the fitting, and then around the intermediate portion 44, and a stop portion 46 formed at the join between the chamfered portion 42 and the intermediate portion 44 makes it possible to hold the flexible duct in position.

The circulation chamber 28 is delimited in the distribution member 6 by a closed envelope 48 having three openings, specifically a first opening 50, which is formed in the cylinder 280 and communicates with the fluid inlet endpiece 30, a second opening 52, which communicates with the fluid outlet endpiece 32, and a third opening 54, which is disposed facing the first face 12 of the casing 10 mentioned above and is dimensioned such that at least part of the piston of the electromagnetic system 5 can extend in the circulation chamber 28.

As illustrated, the third opening 54 and the second opening 52 are aligned in the longitudinal direction A, being formed on either side of the circulation chamber 28. In this way, the longitudinal displacement movement of the piston makes it possible to bring the free longitudinal end 26 of this piston up against the second opening 52, or away therefrom, and to thus prevent or allow the circulation of cleaning fluid between the circulation chamber 28 and the fluid outlet endpiece 32.

The envelope 48 extends overall in the form of a cylindrical element centered on an axis parallel to the longitudinal direction A, and across which extends the cylinder 280 configured to communicate with the fluid inlet endpiece 30. In other words, in the example illustrated, the fluid inlet endpiece extends transversely to the rest of the solenoid valve, which extends essentially in the longitudinal direction.

The envelope 48 has a first longitudinal edge 56 configured to be in contact with the electromagnetic system 5, this first edge 56 delimiting a first substantially discoid face 58, in which is the third opening 54 of the envelope 48. The envelope 48 has a second longitudinal end edge 60 which is opposite the first edge 56 in the longitudinal direction A and delimits a second substantially discoid face 62 projecting from which the fluid outlet endpiece 32 extends. The envelope 48 thus has a substantially cylindrical peripheral wall 64 which connects the first and second edges 56, 60 of the envelope 48 and which is continued transversely by the cylinder 280 making it possible to communicate with the fluid inlet endpiece as mentioned above.

The fluid outlet endpiece 32 has a shape substantially equivalent to that of the fluid inlet endpiece 30 described above, with a sleeve 66 which projects from the second face 62 of the envelope 48 and is configured to interact with the spraying member 8. The sleeve 66 extends longitudinally, having a free longitudinal end 68 and being passed through longitudinally by a fluid outlet duct 70 leading into the circulation chamber 28, on the one hand, and opening out at the free end 68 of the sleeve 66, on the other hand. As illustrated in FIG. 6, the fluid outlet duct 70 may have a substantially constant inside diameter.

There as well, as for the fluid inlet endpiece, the sleeve 66 is subdivided into multiple portions, specifically, in succession from the free end 68 to the envelope 48: a first end portion 72, a chamfered portion 74, an intermediate portion 76, and a second end portion 78.

The first end portion 72 comprises a flexible ring 80 forming a sealing element at the join with the spraying member when the sleeve 66 is fitted in a corresponding orifice of the spraying member.

The chamfered portion 74 forms a ramp making it easier to fit the spraying member onto the fluid outlet endpiece, and, like for the fluid inlet endpiece, this chamfered portion contributes to defining, at its join with the intermediate portion 76, a stop 84 extending radially with respect to the sleeve 66 and contributing to locking the longitudinal position of the spraying member 8 with respect to the solenoid valve 3 once it has been mounted on the fluid outlet endpiece 32.

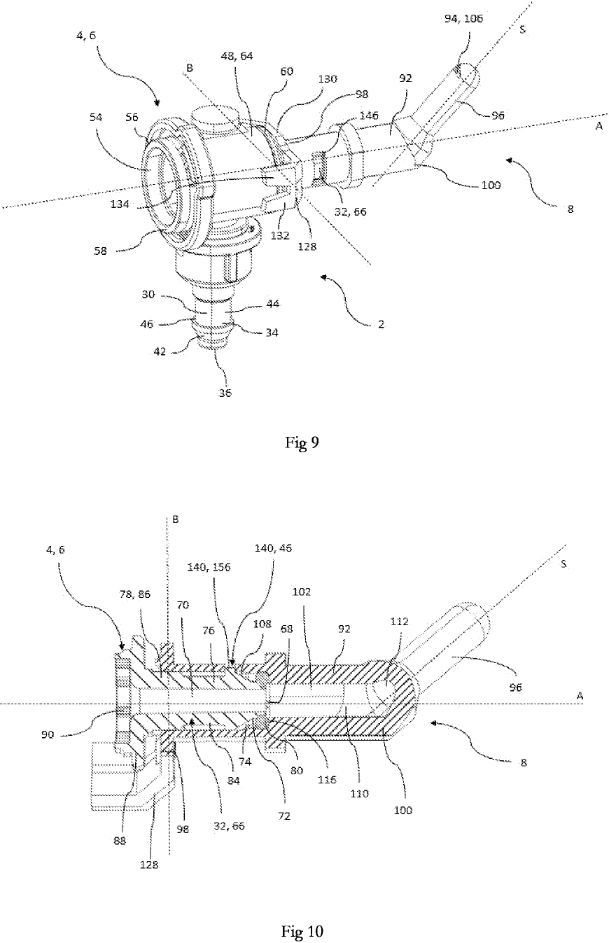

The second end portion 78 notably has a cylindrical portion 86, arranged in line with the intermediate portion 76, and a plate 88, which has a larger diameter than the cylindrical portion and forms a base that is able to be pressed against the second face 62 of the distribution member 6 and forms a support for complementary fixing means 90, for example a thread, as can be seen for example in FIG. 10, which illustrates another embodiment, making it possible to ensure the fixing of the sleeve 66 of the fluid outlet endpiece to the envelope 48 of the distribution member 6.

As specified above, the fluid outlet endpiece 32, and more generally the distribution member 6, is intended to interact with the spraying member 8, the latter being fixed directly to the member 6 of the solenoid valve 3.

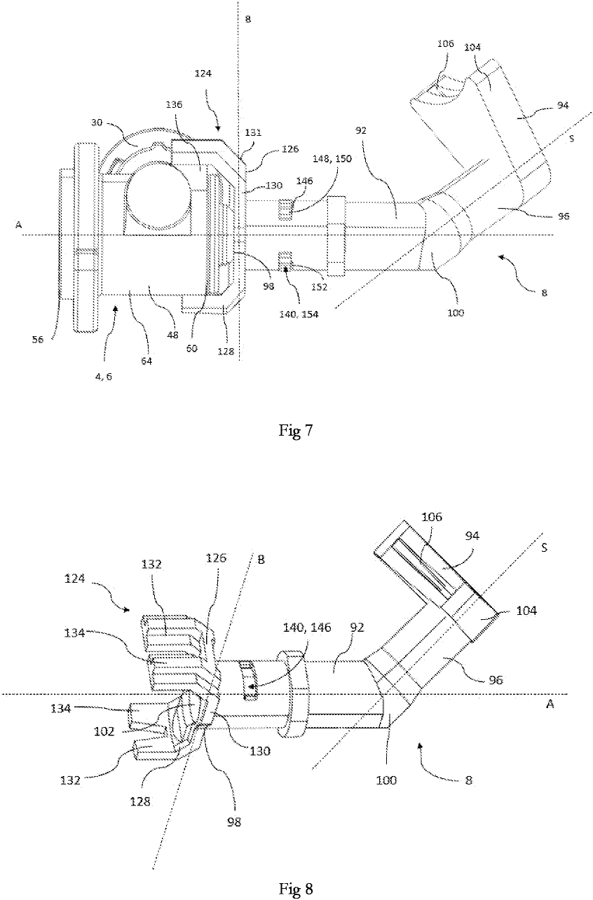

A more detailed description, notably with reference to FIG. 7 and FIG. 8, will now be given of the spraying member 8 according to the first embodiment of the invention, with a description of the means of interaction between the member 6 and the spraying member 8.

The spraying member 8 comprises at least one coupling tube 92 and a spray nozzle 94, and also a distribution body 96 configured to fluidically connect the coupling tube 92 to the spray nozzle 94.

The coupling tube 92 forms that part of the spraying member that is directly fixed to the sleeve 66 of the fluid outlet endpiece 32. More particularly, the coupling tube 92 extends essentially along the longitudinal direction A between a first longitudinal end 98, facing the distribution member 6, and a second longitudinal end 100, which faces away from the distribution member 6 and is secured to the distribution body 96.

The distribution body 96 has the form of a hollow tube, the function of which is to supply the spray nozzle with cleaning fluid after the latter has passed through the coupling tube 92. As illustrated, the distribution body is distinguished from the coupling tube by its overall orientation, along a direction S that intersects the longitudinal direction A. This orientation of the distribution body 96, forming an angle with the longitudinal direction A, makes it possible to orient the spray nozzle 94 such that the cleaning fluid is sprayed optimally onto the surface to be cleaned, specifically in this case the optical surface of a sensor/emitter. It will be understood that the presence of this distribution body and its orientation inclined with respect to the longitudinal direction might not be necessary if the spray nozzle 94 can be arranged directly in the continuation of the coupling tube 92.

As illustrated more particularly in FIG. 6, the coupling tube 92, the distribution body 96 and the spray nozzle 94 are hollow so as to form a conveying duct 102 inside the spraying member 8, which makes it possible to convey fluid from the distribution member 6 to the spray nozzle 94. In this case, the spray nozzle has a spray head 104 with a spray orifice 106, with the conveying duct 102 then extending to the spray orifice 106.

The conveying duct 102 is delimited by a wall of each of the components of the spraying member 8, each wall having an internal dimension, here an inside diameter when the conveying duct is cylindrical overall, which is different from one to another and thus delimits various segments of the conveying duct 102. From the first longitudinal end 98 of the coupling tube 92 to the spray orifice 106 of the spray nozzle 94, a distinction can be made in this way in the conveying duct 102 between the following segments: an interaction segment 108 for interacting with the fluid outlet endpiece 32, a coupling segment 110, a distribution segment 112, and a spraying segment 114.

The interaction segment 108 of the coupling tube 92 is delimited by a wall having an inside diameter which is substantially equal to the outside diameter of the sleeve 66, for example measured at the stop 84. This makes it possible to mount the spraying member 8 around the outlet endpiece 32 of the distribution member 6 in a tight-fitting manner. Moreover, the length of the interaction segment 108 is substantially equivalent to a length of the sleeve 66, such that the free end of the sleeve 66 is positioned substantially at the level of a shoulder 116 forming a join between the interaction segment 108 and the coupling segment 110.

The coupling segment 110, also formed at the level of the coupling tube 92, is delimited by a wall having an inside diameter which is reduced in comparison with the inside diameter contributing to the definition of the interaction segment 108, and in this way this reduction in diameter creates the shoulder 116 previously mentioned. As can be seen in FIG. 6, the diameter of the coupling segment 110 is substantially the same as that of the fluid outlet duct 70, such that the fluid can flow continuously and at a constant pressure between the distribution member 6 and this part of the spray member 8.

The distribution segment 112 continues the conveying duct 102 from the coupling segment 110 to the spray nozzle 94 through the distribution body 96. The distribution segment 112 is delimited by a wall with an inside diameter which becomes smaller as it gets further away from the coupling segment 110, thus forming a funnel profile as it gets close to the spray orifice 106. The aim is thus to increase the pressure or flow rate of the cleaning fluid in the vicinity of the spray orifice in order to spray a cleaning fluid that can strip away the dirt covering the optical surface of the associated sensor.

The spray segment 114, present at the spray nozzle 94, has a smaller cross section than the cross sections of the other segments of the conveying duct 102, thereby providing the connection between the distribution segment 112 and the spray orifice 106. There as well, the aim is to accelerate the cleaning fluid at the outlet of the spraying member.

To mount the spraying member 8 on the distribution member 6, the coupling tube 92 is slid around the sleeve 66 along the longitudinal direction A until the free end 68 of the sleeve 66, and notably the flexible ring 80 arranged at this free end 68, comes into contact with the shoulder 116 delimiting the join between the interaction segment 108 and the coupling segment 110.

Once the spraying member 8 has been mounted on the distribution member 6 of the solenoid valve 3, the cleaning fluid can circulate from the fluid inlet endpiece 30 of the distribution member 6 to the spray orifice 106 if the solenoid valve is in a configuration enabling the passage of fluid in the direction of the spraying member. In this case, the cleaning fluid circulates in succession from the fluid inlet endpiece 30 through the circulation chamber 28, then through the fluid outlet endpiece 32, and then, lastly, by entering the spraying member 8, through the coupling segment 110, the distribution segment 112, the spray segment 114, and then the spray orifice 106, as have just been described.

Because of its contact with the shoulder when the spraying member is fitted around the fluid outlet endpiece, the flexible ring 80 contributes to the sealing of the spraying device at the interaction segment 108, ensuring that all of the cleaning fluid flowing through the outlet endpiece 32 passes in the direction of the distribution body 96 and the spray nozzle 94. As has been specified above, making the inside diameter delimiting these various segments smaller makes it possible to increase the speed of circulation of the cleaning fluid through the conveying duct 102 until this fluid reaches a speed necessary for it to be sprayed onto an optical surface to ensure the latter is cleaned.

A more detailed description will now be given of the means for interaction between the distribution member 6 and the spraying member 8, notably with reference to FIG. 5, FIG. 6, FIG. 7, and FIG. 8, which interaction means consist on the one hand of fixing means enabling the spraying member to be fixed directly to the solenoid valve and on the other hand of poka-yoke means making it possible to ensure a suitable mounting direction.

The spraying device according to the invention comprises at least one poka-yoke device 124 for the mounting of the spraying member 8 on the solenoid valve 3, in order to ensure the correct orientation of the spray nozzle 94 facing the optical surface to be cleaned.

On the spraying member 8, the poka-yoke device 124 in this case takes the form of a first positioning tab 126 and a second positioning tab 128, each projecting from the coupling tube 92 at its first longitudinal end 98 so as to overlap the distribution member 6 when the spraying member 8 is fixed to the latter.

In the example illustrated, the positioning tabs forming the poka-yoke device are disposed on the edge delimiting the first longitudinal end 98 diametrically opposite one another.

Each of the positioning tabs 126, 128 comprises a base wall 130 continuing the coupling tube by extending along a transverse direction B which is substantially perpendicular to the longitudinal direction A along which the coupling tube 92 mainly extends. At the end of this base wall, each positioning tab has at least a first finger 132 perpendicularly continuing the base wall 130 by extending along a direction substantially parallel to the longitudinal direction A, in the direction of the distribution member 6, that is to say away from the spraying member 8. The base wall 130 of each of the positioning tabs 126, 128 may be continued by a second finger 134 which extends at the side of the first finger 132, substantially parallel to the longitudinal direction A.

In the example illustrated, and as can be seen notably in FIG. 7, an intermediate wall 131 is formed between the base wall 130 and the fingers 132, 134 continuing it, in order to give the fingers 132, 134 flexibility in bending. This intermediate wall 131 has an orientation inclined in relation to the respective orientations of the base wall and the fingers, such that the intermediate wall 131 forms a chamfer area of the corresponding positioning tab.

On the spraying member, the poka-yoke device 124 is formed by a structural difference between the first positioning tab 126 and the second positioning tab 128. As illustrated in FIG. 7 and FIG. 8, the base wall 130 and/or the intermediate wall 131 of the first positioning tab 126 has a transverse dimension, measured in the transverse direction B, which is larger than the corresponding transverse dimension of the base wall 130 and/or of the intermediate wall 131 of the second positioning tab 128. In this way, if an axis of elongation of the spraying member is defined as the axis on which the coupling tube is centered, the positioning tabs differ in that the fingers 132, 134 of the first positioning tab 126 extend longitudinally at a distance from the axis of elongation of the spraying member which is greater than the corresponding distance to which the fingers of the second positioning tab 128 extend.

This structural difference makes it possible to ensure that the spraying member is in the correct direction, that is to say with the spray nozzle correctly oriented to spray fluid onto the optical surface to be cleaned, at the time the spraying member 8 is directly fixed to the solenoid valve 3.

As can be seen notably in FIG. 5, FIG. 6, and FIG. 7, on its peripheral wall 64, the envelope 48 of the distribution member has a low wall 136 which forms a local protuberance on the second longitudinal end edge 60 and which is secured to the cylinder 280. The low wall 136 is a parallelepipedal block projecting from the envelope 48 along the transverse direction B, a flat face 138 of which low wall extends away from the envelope. Since the low wall 136 forms a local protuberance, the transverse dimension of the envelope 48 at this wall 136 is larger than the corresponding dimension of the envelope 48 at a diametrically opposite point. This difference in transverse dimension means that only the fingers 132, 134 of the first positioning tab 126 can be positioned against the flat face 138 of the low wall 136 when the spraying member 8 is mounted on the solenoid valve, the difference between the transverse dimension of the first positioning tab 126 and the transverse dimension of the second positioning tab 128 being substantially equal to the transverse dimension of the low wall 136. The fingers of the second positioning tab 128 are then in contact with the envelope 48 in an area diametrically opposite the low wall 136.

It will be understood that if the spraying member is mounted the wrong way around, that is to say with the second positioning tab 128 angularly positioned at the low wall 136, the fingers of this second positioning tab 128 would come into contact with this low wall and would prevent the spraying member 8 being inserted close enough to the distribution member 6 to allow it to be fixed. The presence of the low wall 136 on the solenoid valve and the different shapes and dimensions of the positioning tabs 126, 128 of the spraying member thus form the poka-yoke device 124 for mounting the spraying member 8 on the distribution member 6.

In alternative embodiments, which in this case are not shown, the poka-yoke device 124 could comprise a rib that projects locally from the coupling tube 92 and is dimensioned to interact with a kerf formed locally along an outer face of the sleeve 66, or could comprise a finger that emerges from the envelope 48 of the distribution member 6 and interacts with a groove formed in an inner face of the coupling tube 92, without thereby departing from the scope of the invention.

As has been mentioned above, the spraying device according to the invention has fixing means making it possible to fix the spraying member to the solenoid valve, and notably the rigid coupling tube 92 to the rigid distribution member 6, directly, that is to say without an intermediate flexible duct.

According to the first embodiment of the invention, the spraying device comprises reversible fixing means 140 making it possible to directly fix the spraying member to the sleeve 66 forming the fluid outlet endpiece 32. It will be understood that these reversible fixing means 140 make it possible to be able to directly fix the spraying member 8 to the solenoid valve, while still allowing the spraying member 8 to be subsequently dismounted without breaking the spraying member 8 or the distribution member 6.

These reversible fixing means 140 in this case have an additional part which forms a locking element 148 and which is assembled once the spraying member 8 has been mounted on the outlet endpiece of the distribution member 6. In this case, the locking element consists of an elastic clamping ring, or circlip, which will be fitted into an opening made in the spraying member 8 so as to lock the longitudinal position of the outlet endpiece inside the spraying member.

More particularly, and as illustrated in FIG. 5 and FIG. 6, the coupling tube 92 of the spraying member 8 has at least one first hole 146, which extends circumferentially in the wall of the coupling tube and which is configured to pass through the wall of the coupling tube and connect the conveying duct 102, and more particularly the interaction segment 108 of this conveying duct, to the outside environment through the wall of the coupling tube. The first hole 146 has a longitudinal dimension substantially equal to that of the locking element 148, and it extends partially around the coupling tube 92.

The first hole is formed at a distance from the first longitudinal end 98 such that the length between the first hole 146 and the shoulder 116 forming the join between the interaction segment 108 and the coupling segment 110 inside the coupling tube 92 is at least equal to, or even greater than, the length of the sleeve 66, measured between the free end 68 and the stop 84 arranged at the join between the intermediate portion 76 and the chamfered portion 74.

These longitudinal dimensions are provided such that, when the sleeve 66 is inserted in the spraying member, the stop 84 is disposed at the limit of the first hole, between the latter and the shoulder 116.

As mentioned above, the locking element 148 is a circlip, in this case in the shape of a U, a first leg 150 of which can be housed in the first hole 146 of the coupling tube 92. This first leg 150 of the circlip is then in contact with the intermediate portion 76 of the sleeve 66, and, with the stop 84, forms means preventing the longitudinal displacement of the sleeve 66 inside the spraying member 8.

In the example illustrated, the coupling tube 92 comprises a second hole 152 diametrically opposite the first hole 146, and a second leg 154 of the circlip is then housed, through the second hole 152, in the interaction segment 108 of the coupling tube 92 symmetrically to the way in which the first leg 150 is housed in the first hole 146, the second leg 154 also being in contact with the intermediate portion 76 of the sleeve 66 and contributing to longitudinally locking the sleeve via the stop 84 of the latter.

The first and second legs 150, 154 of the circlip are spaced apart from one another in an initial form of the circlip, as can be seen in FIG. 5, by a distance less than that of the diameter of the coupling tube, such that the legs are deformed by being moved away from one another when the circlip is arranged around the coupling tube. Once each leg faces the corresponding hole, the elastic return effect of the circlip tends to make each leg engage in the hole so as to make it possible to hold the spraying member 8 in position on the sleeve 66 by locking the chamfered portion 74 and the first end portion 72 of the sleeve 66 between the legs 150, 154 of the circlip and the shoulder 116 of the coupling tube 92. The vibrations of the spraying device 2 while it is operating or while the vehicle is moving are not enough to move the legs away from one another, such that the direct fixing between the spraying member and the solenoid valve is reliable, and dismounting the assembly is made possible by an action on the part of a user, who can move the legs of the circlip away from one another in order to disengage the spraying member 8 from the solenoid valve, if required.

A description will now be given, with reference to FIG. 9 and FIG. 10, of a second embodiment of the cleaning fluid spraying device of the invention, which differs notably from the aforesaid in terms of the form of the spray nozzle 94 and the realization of the reversible fixing means 140 making it possible to fix the spraying member 8 directly to the sleeve 66 forming the fluid outlet endpiece 32. Thus, in FIG. 9 and FIG. 10, only the spraying member 8 and the distribution member 6 are illustrated, the electromagnetic system 5 of the solenoid valve 3 being able to be used in an identical way to that described above.

The spray nozzle 94 in this case has a simplified form and in this case consists solely of the spray orifice 106.

As described above, the reversible fixing means 140 have a first hole 146 formed in the coupling tube 92, as described above for the first embodiment. This hole 146 is configured to receive an elastically deformable element, in accordance with the first embodiment in which this elastically deformable element was formed by the circlip.

In this case, the elastically deformable element able to interact with the at least one hole is formed by the free end of the sleeve 66 of the fluid outlet endpiece, which can be deformed between its original shape and a retracted shape, in which the inside diameter of the fluid outlet duct 70 is smaller. The elastically deformable element also has a snap-fastening finger 156, arranged at the join between the chamfered portion 74 and the intermediate portion 76, over a longitudinal dimension substantially equal to the corresponding longitudinal dimension of the first hole 146. This snap-fastening finger 156 forms a radial projection on the sleeve of the fluid outlet endpiece which can be housed in the first hole 146 when the fluid outlet endpiece is inserted as far as the shoulder 116 inside the spraying member 8. The snap-fastening finger 156 forms a radial projection on the sleeve in that it extends at a distance from the longitudinal axis A on which the sleeve 66 is centered that is greater than any other part of the sleeve intended to be inserted into the spraying member 8.

As can be seen, the first longitudinal end 98 of the coupling tube 92 has a chamfered edge making it possible to facilitate the insertion of the snap-fastening finger 156 into this coupling tube 92 of the spraying member by initiating the elastic deformation of the free end of the sleeve. It should be noted that reverse elastic deformation of the coupling tube may take place, specifically a widening of this coupling tube, to allow the passage of the snap-fastening finger. Once the spraying member 8 has been fitted around the fluid outlet endpiece 32 far enough for the snap-fastening finger 156 to face the first hole 146, the elastic return effect, both that of the sleeve 66 and that of the coupling tube, tends to return the components to their initial shape and the snap-fastening finger 156 is housed in the first hole 146 of the coupling tube 92.

Once the snap-fastening finger 156 is housed in the first hole 146 of the coupling tube 92, the spraying member 8 is held in position around the sleeve 66, preventing any movement of the spraying member 8 along the longitudinal direction A.

This fixing means for fixing the spraying member 8 to the distribution member 6 is also referred to as reversible since the user can dismount the spraying member 8 from the distribution member 6 without breaking one of the objects. If the user wishes to dismount the spraying member 8 from the distribution member 6, they can exert a pressure on the snap-fastening finger 156 to dislodge it from the first hole 146 and at the same time pull longitudinally on the spraying member 8 to move it away from the solenoid valve.

It will be understood that this snap-fastening fixation could be implemented equivalently with two opposite holes as described in the first embodiment, and with two snap-fastening fingers.

In this latter case, it is enough to equip the spraying device with a poka-yoke device 124, which can take the same form as in the first embodiment. It would also be possible to provide doing without the poka-yoke device in the form of positioning tabs as described above if a single snap-fastening finger and a single hole are provided, since the angular position of the spray nozzle 94 will be necessarily correct as long as the single snap-fastening finger and the single hole interact. However, even in this case, a poka-yoke device can be an additional means for ensuring that the snap-fastening finger and the hole are aligned and interact well together when the spraying member is completely fitted to the fluid outlet endpiece of the solenoid valve.

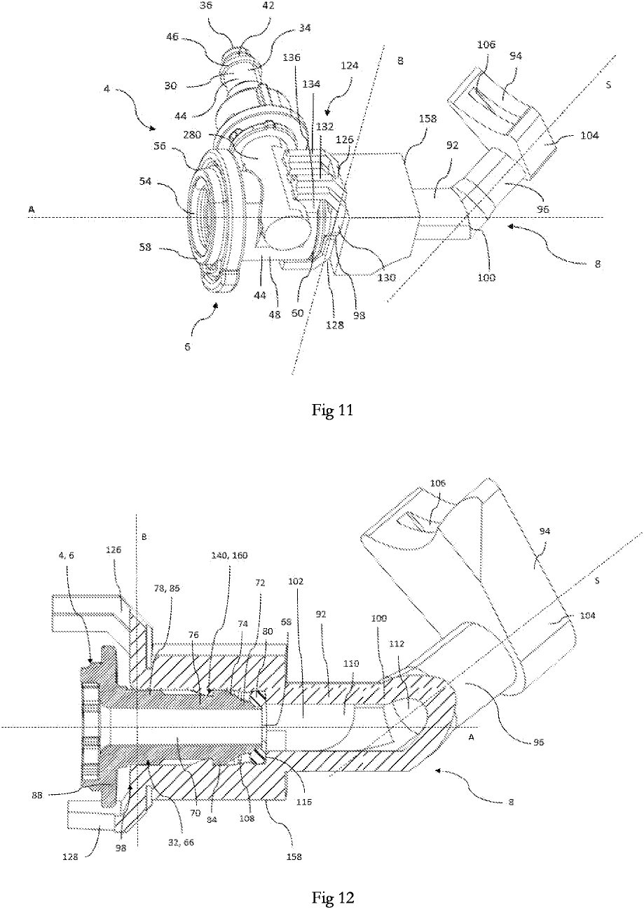

A description will now be given of a third embodiment with reference to FIG. 11 and FIG. 12, which differs from the first embodiment in terms of the form of the reversible fixing means 140.

The spraying member 8 has a parallelepipedal block 158 partially surrounding the coupling tube 92 from the positioning tabs 126, 128 to the distribution body 96. The form of the parallelepipedal block in this case is only illustrative and does not limit the invention, it being understood that the main function of this block is to locally increase the thickness of the coupling tube so as to be able to incorporate, in the inner face of its wall delimiting the interaction segment 108 of the conveying duct 102, a protuberance forming a snap-fastening finger.

More particularly, and as can be seen in FIG. 12, the coupling tube, at the level of this block 158, has at least one protuberance 160 projecting radially across the interaction segment 108 of the conveying duct 102. The protuberance 160 may notably extend over the entire periphery of the wall delimiting this interaction segment 108 of the conveying duct. The protuberance 160 has a first face forming a ramp oriented toward the first end 98 of the sleeve 66 and a second, straight face, which faces away therefrom and is able to form a longitudinal stop face. The protuberance 160 is dimensioned such that the transverse dimension of the conveying duct 102 at the join between the first face and the second face of the protuberance is substantially equal to the transverse dimension of the sleeve in its intermediate portion 76, which forms a clearance free of material between the chamfered portion 74 and the second end portion 78. As illustrated, the protuberance 60 may have a similar shape, but in an opposite arrangement, to that of the chamfered portion 74 of the sleeve 66.

Moreover, the protuberance 160 is formed in the coupling tube 92 such that the length measured between the second face of the protuberance, forming a longitudinal stop surface, and the shoulder 116 is slightly larger than the longitudinal dimension of the sleeve 66 between the free end 68 and the stop 84 delimiting the intermediate portion 76 of the chamfered portion 74.

The protuberance 160 is made of the same material of which the coupling tube 92 is made, but may alternatively be made of a different material promoting its elastic deformation.

When the spraying member 8 is being mounted on the distribution member 6, the coupling tube 92 slides along the longitudinal direction A around the sleeve 66, thus moving the protuberance 160 of the coupling tube 92 close to the chamfered portion 74 of the sleeve 66. The longitudinal movement involves contact between the two ramp-forming surfaces that are respectively formed on the protuberance and on the chamfered portion 74, such that the longitudinal displacement can be continued with less force, at least one of these parts elastically deforming to enable this longitudinal movement to continue. The movement is continued until the chamfered portion 74 is housed in the conveying duct 102 between the protuberance 160 and the shoulder 116 of the coupling tube 92. Therefore, each of the parts returns to its initial shape and the protuberance 160 is positioned in the clearance formed by the intermediate portion 76, thereby preventing, by abutting the chamfered portion 74, any movement of the spraying member 8 along the longitudinal direction A.

To dismount the spraying member 8 from the distribution member 6, a user must move the operating tabs away from one another to deform the sleeve and enlarge the passage cross section at the protuberance, so as to be able to release the chamfered portion 74 from the space delimited by the protuberance 160 and the shoulder 116 of the coupling tube 92.

However, the invention is not limited to the means and configurations described and illustrated here, but also extends to any equivalent means or configuration described and illustrated here, and also extends to any equivalent means or configuration and to any technically operational combination of such means. In particular, other reversible fixing means could be implemented provided that they make it possible for the spraying member to be fixed directly to the solenoid valve.

What is claimed is:

1. A fluid spraying device for a system for cleaning a surface of a motor vehicle, the spraying device comprising a solenoid valve configured to allow or prevent the passage of fluid in the direction of a spraying member, the solenoid valve having a hydraulic system and an electromagnetic system, the hydraulic system including at least one fluid distribution member which has at least one fluid inlet endpiece, a circulation chamber, and a fluid outlet endpiece in fluidic communication with the spraying member, the electromagnetic system being configured to allow or prevent the passage of fluid through the circulation chamber, wherein the spraying member includes at least one coupling tube and a spray nozzle which are formed in one piece, the coupling tube being directly fixed to the fluid outlet endpiece.

2. The fluid spraying device as claimed in claim 1, thatwherein the spraying member is fixed directly to the fluid outlet endpiece by reversible fixing means.

3. The fluid spraying device as claimed in claim 2, wherein the reversible fixing means are borne respectively by the fluid outlet endpiece and by the coupling tube of the spraying member member, at least one from among the fluid outlet endpiece and the coupling tube tube being able to take different positions by elastically deforming.

4. The fluid spraying device as claimed in claim 3, thatwherein the reversible fixing means have a snap-fastening finger projecting from a wall delimiting a sleeve forming the fluid outlet endpiece, the snap-fastening finger being configured to interact with a hole formed in the wall delimiting the coupling tube.

5. The fluid spraying device as claimed in claim 3, thatwherein the reversible fixing means have a protuberance which projects from a wall delimiting the coupling tube toward the inside of this coupling tube tube and is configured to interact with a stop projecting from a sleeve forming the fluid outlet endpiece, after elastic deformation of the wall bearing the protuberance and/or of the sleeve bearing the stop.

6. The fluid spraying device as claimed in claim 2, thatwherein the reversible fixing means have a locking element separate from the spraying member and from the fluid outlet endpiece, the locking element being elastically deformable and able to interact with at least one hole formed in the wall delimiting the coupling tube.

7. The fluid spraying device as claimed in claim 1, further comprising a poka-yoke device.

8. The fluid spraying device as claimed in claim 7, wherein the poka-yoke device has a plurality of positioning tabs projecting from the coupling tube so as to at least partially cover the distribution member and among which at least one positioning tab has a shape and dimensions different to those of the other positioning tabs, the poka-yoke device moreover having a low wall wall formed at the periphery of the distribution member to interact with the positioning tab that has a shape and/or dimensions different to those of the other positioning tabs.

9. The fluid spraying device as claimed in claim 1 wherein the spraying member has a conveying duct, which extends within the spraying member continuously from the coupling tube to the spray nozzle, and in which is inserted the fluid outlet endpiece, the conveying duct having a 6)shoulder arranged between two segments of the conveying duct that have different passage cross sections, the shoulder forming an end stop for the insertion of the fluid outlet endpiece into the spraying member.

10. A system for cleaning a surface of a motor vehicle, comprising a pump conveying a cleaning fluid through a duct to at least one solenoid valve of a spraying device, the solenoid valve being configured to allow or prevent the spraying of the fluid onto the surface via the spraying member, with the solenoid valve having a hydraulic system and an electromagnetic system, the hydraulic system including at least one fluid distribution member which has at least one fluid inlet endpiece, a circulation chamber, and a fluid outlet endpiece in fluidic communication with the spraying member, the electromagnetic system being configured to allow or prevent the passage of fluid through the circulation chamber, wherein the spraying member includes at least one coupling tube and a spray nozzle which are formed in one piece, the coupling tube being directly fixed to the fluid outlet endpiece.

11. The fluid spraying device as claimed in claim 7, wherein the poka-yoke device has a plurality of positioning tabs projecting from the coupling tube so as to at least partially cover the distribution member and among which at least one positioning tab has a shape or dimensions different to those of the other positioning tabs, the poka-yoke device moreover having a low wall formed at the periphery of the distribution member to interact with the positioning tab that has a shape and/or dimensions different to those of the other positioning tabs.
